(19) United States
(12) Patent Application Publication
(10) Pub. No.: US 2001/0008530 A1
(43) Pub. Date: Jul. 19, 2001

(54) Shaper and scheduling method for use in the same

(75) Inventor: Tsugio Okamoto, Tokyo (JP)

Correspondence Address: YOUNG & THOMPSON, 745 SOUTH 23RD STREET 2ND FLOOR, ARLINGTON, VA, 22202

(73) Assignee: NEC CORPORATION

(21) Appl. No.: 09/764,283

(22) Filed: Jan. 19, 2001

(30) Foreign Application Priority Data
Jan. 19, 2000 (JP) 009602/2000

(51) Int. Cl. H04L 12/54

(52) U.S. Cl. 370/428; 370/412

(57) ABSTRACT

A shaper allowing an arbitrary transmission time and simultaneous transmission of a plurality of packets is disclosed. A content-addressable memory stores a plurality of scheduled transmission times, at each of which at least one packet is to be transmitted. A packet management table stores linkage information indicating a linkage of a plurality of packets that are to be transmitted at a same scheduled transmission time. A current-time searcher searches the content-addressable memory for a scheduled transmission time matching the current time. At least one packet can be transmitted at the scheduled transmission time matching the current time by referring to the packet management table.

### BACKGROUND OF THE INVENTION

1. Field of the Invention

The present invention relates to a shaper and a scheduling method for use in the same, and relates, more particularly, to a shaper for controlling transmission of data blocks such as cells or packets to a network and a scheduling method for use in the shaper.

2. Description of Related Art

A shaper has been used for effectively using network resources by controlling a data block of a fixed length called a cell or of a variable length called a packet (hereinafter a cell and a packet will be collectively called a packet) in a network that utilizes ATM (Asynchronous Transfer Mode) or IP (Internet Protocol) technology.

A user who utilizes a network uses a traffic parameter to declare a necessary resource, and a network provider forms a network based on the traffic declared by the user.

However, there is considered a case where the user transmits packets with a violation of the declared traffic parameter. In this case, there is a possibility that the user uses network resources of other users who are not against their declared traffic parameters. Therefore, the provider of the network needs to monitor the traffics at all times. When the network provider has found a violation use of network resources as a result of monitoring the traffics, the provider generally discards a violating packet or transfers this packet back to the sender based on its traffic parameter declared by the user, before transferring it into the network,

When transferring packets to the network, the user uses a shaper to transmit a traffic Meeting the traffic parameter to the network so that packets are not discarded due to a violation of the declared traffic parameter by the network provider.

A series of packets that are transferred on the network can be expressed in detailed numerical values as traffic parameters. In ATM network, the Leaky Bucket model is used to express the traffic parameters, and in IP network, the Token Bucket model is used to express the traffic parameters.

A violation of traffic is a case where a packet arrives in a shorter interval than calculated based-on a previously declared traffic parameter. A shaper shortens this violating short arrival time interval by re-transmitting packets so as not to violate the previously declared traffic parameter,

As one of functions of the shaper, packet transmission scheduling for transmitting a packet at an ideal time is needed. As one of methods for this scheduling, packets are queued, ideal times thereof are calculated using traffic parameters, the ideal times are counted using a timer, and packets are transmitted at the ideal times indicated by the counter. This method is effective when there is only one flow of packets. However, in actual practice, it is general that the shaper handles a plurality of packet flows. Therefore, it is necessary for the shaper to be provided with timers as many as packet flows, which is not realistic.

As a time management method for each flow of packets, there has been proposed a matrix-based algorithm. One element of the matrix corresponds to one time managed by a timer. In order to schedule transmission of a packet of a certain flow number so as to transmit it at an ideal time, the flow number is written into an element location of the matrix corresponding to the ideal time.

The timer shows a current time. Each time when the time of the timer progresses, the matrix number corresponding to the current time is accessed to determine whether a packet to be transmitted at the current time exists. According to this method using the matrix, only one timer needs to be prepared, and this method has an advantage in that only a bit width necessary for the matrix increases even when the number of packet flows increases.

However, according to the matrix-based method, when the time range that can be set is made wider, the size of the matrix needs to be increased in proportion to the size of this time range, As a result, a large-capacity memory (RAM: random-access memory) is needed, causing a problem in that it is necessary to limit the size on the settable time range to a small level in actual practice.

In order to solve these problems, there has been proposed a method utilizing a CAM (content-addressable memory) that does not require a memory capacity to be in proportion to the settable time range and that does not increase the number of timers when the number of flows is increased.

Such a CAM-used traffic shaping method has been disclosed in Japanese Patent Application Unexamined Publication No. 10-23037. More specifically, a traffic shaper is provided with a plurality of call buffers having a buffer number assigned thereto. The CAM has a time instant corresponding to each buffer number registered thereto. When the current time matches a registered time instant, the CAM outputs a corresponding buffer number to permit a corresponding cell buffer to send a cell. At the same time, a sending interval table outputs a transmission interval for the buffer number to a transmission time calculator. The transmission time calculator calculates a next transmission time for the buffer number and registers it on the CAM. In this manner, the traffic shaping for a plurality of cell buffers can be performed.

According to the above-described conventional CAM-used traffic shaping method however, a processing operation has not been assumed for the case where there exist a plurality of packets that are to be transmitted at the same time. When the transmission of a plurality of packets at the same time is set to the CAM, only one of those packets can be output. Further, since the CAM cannot return a plurality of addresses at the same time, the CAM may return an error. This results in a problem that it is not possible to transmit even one packet, and that packets are pooled sequentially in the buffer, leading to a buffer overflow. As a result, it is not possible to carry out the packet transmission processing as expected.

In addition, the transmission of packets from each buffer at constant time intervals has been assumed. Therefore, this method cannot be utilized for determining a transmission time based on a packet arrival time and a traffic parameter.

### SUMMARY OF THE INVENTION

In order to eliminate the above problems, it is, therefore, an object of the present invention to provide a shaper and a scheduling method allowing simultaneous transmission of a plurality of packets using a CAM.

It is another object of the present invention to provide a shaper and a scheduling method capable of setting a packet transmission time based on a packet arrival time and a traffic parameter.

According to an aspect of the present invention, a shaper for controlling a plurality of flows of packets, includes: a packet buffer for storing packets for each of the flows of packets; a content-addressable memory for storing a plurality of scheduled transmission times at different addresses each corresponding to the flows of packets; a timer counting a current time; and a current-time searcher for searching the content-addressable memory for a scheduled transmission time matching the current time to determine whether a packet to be transmitted at the current time exists.

Since the content-addressable memory stores a plurality of scheduled transmission times at different addresses each corresponding to the flows of packets, the flow number of a packet can determine the address at which the scheduled transmission time is registered.

According to another aspect of the present invention, a shaper includes: a packet buffer for storing packets for each of the flows of packets; a content-addressable memory for storing a plurality of scheduled transmission times, at each of which at least one packet is to be transmitted; a packet management table for storing linkage information indicating a linkage of a plurality of packets that are to be transmitted at a same scheduled transmission time; a timer counting a current time; a current-time searcher for searching the content-addressable memory for a scheduled transmission time matching the current time; and a packet transmission controller for transmitting at least one packet at the scheduled transmission time matching the current time by referring to the packet management table.

Since the content-addressable memory and the packet management table are used to schedule packet transmission time, a plurality of packets can be sequentially transmitted at the same transmission time.

The shaper may further include: a scheduler for calculating a transmission time of an input packet based on its predetermined traffic; a same-time searcher for searching the content-addressable memory to determine whether the calculated transmission time matches a scheduled transmission time that has been already registered in the content-addressable memory; and a transmission registration controller for adding the input packet to the linkage for the calculated scheduled transmission time in the packet management table, when the calculated transmission time matches a scheduled transmission time that has been already registered in the content-addressable memory.

The shaper may further include a data update controller for eliminating the scheduled transmission time matching the calculated transmission time from entries to be searched for in the content-addressable memory. The data update controller may remove a packet that has been transmitted from a corresponding linkage stored in the packet management table.

The data update controller may use a valid/invalid flag to determine whether a scheduled transmission time is eliminated from entries to be searched for in the content-addressable memory.

The transmission registration controller may register a flow number of the input packet into the content-addressable memory as an address of the content-addressable memory, when the calculated transmission time does not match any scheduled transmission time of the content-addressable memory.

The scheduler may calculate a transmission time of an input packet so as to meet its predetermined traffic parameter.

According to still another aspect of the present invention, a scheduling method includes the steps of: a) calculating a transmission time of an input packet based on its predetermined traffic; b) searching a content-addressable memory to determine whether the calculated transmission time matches a scheduled transmission time that has been already registered in the content-addressable memory; c) when the calculated transmission time matches a scheduled transmission time that has been already registered in the content-addressable memory, adding the input packet to a linkage for the calculated scheduled transmission time in a packet management table: d) when the calculated transmission time does not match any scheduled transmission time of the content-addressable memory, registering a flow number of the input packet into the content-addressable memory as an address of the content-addressable memory; e) searching the content-addressable memory for a scheduled transmission time matching a current time at predetermined intervals; and f) transmitting at least one packet at the scheduled transmission time matching the current time by referring to the packet management table.

### BRIEF DESCRIPTION OF THE DRAWINGS

FIG. 1 in a block diagram showing an internal circuit of a shaper according to an embodiment of the present invention;

FIG. 2 is a diagram showing a table stored in a content-addressable memory (CAM) in FIG, 1;

FIG. 3 is a diagram showing a first table hold by a same-time transmission packet management table in FIG. 1;

FIG. 4 is a diagram showing a second table held by the same-time transmission packet management table in FIG. 1;

FIG. 5 is a diagram showing a first table for managing packets belonging to the same flow;

FIG. 6 is a diagram showing a second table for managing packets belonging to the same flow;

FIG. 7 is a diagram showing a state of the CAM table and the first and second tables in the case where there is only one packet to be transmitted at the same time;

FIG. 8 is a diagram showing a state of the CAM table and the first and second tables in the case where there are a plurality of packets to be transmitted at the same time;

FIG. 9 is a flowchart showing a part of the operation of a shaper at the time of inputting a packet according to the embodiment of the present invention;

FIG. 10 is a flowchart Showing the other part of the operation of the shaper at the time of inputting a packet according to the embodiment of the present invention;

FIG. 11 is a flowchart showing a part of the operation of a shaper at the time of outputting a packet according to the embodiment of the present invention; and

FIG. 12 is a flowchart showing the other part of the operation of a shaper at the time of outputting a packet according to the embodiment of the present invention.

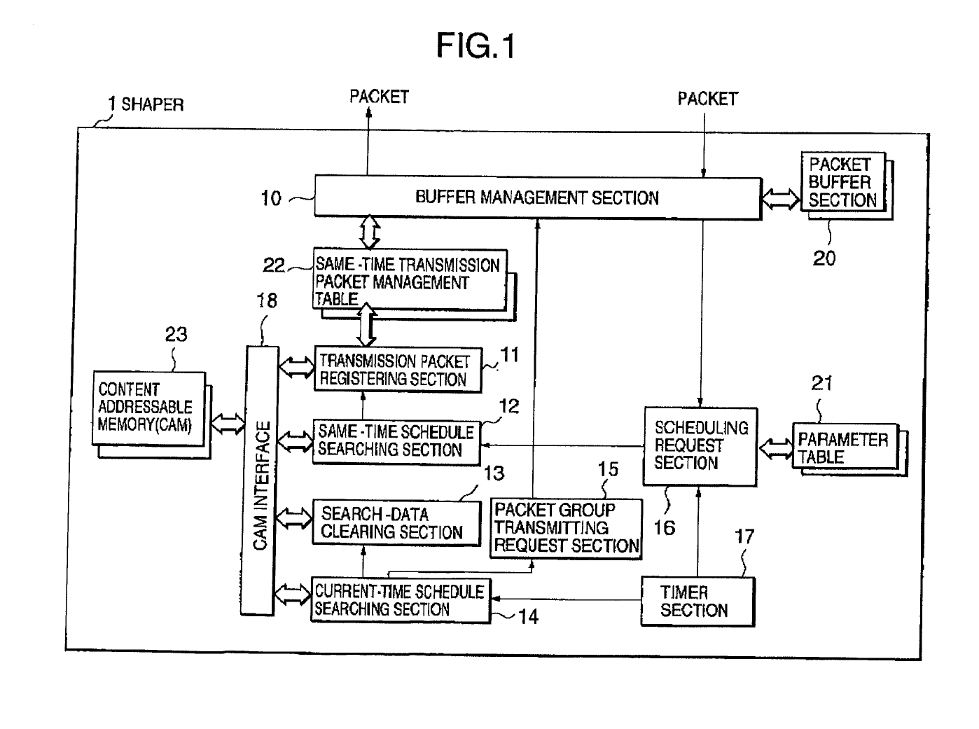

### DESCRIPTION OF THE PREFERRED EMBODIMENT

Referring to FIG. is a shaper 1 according to an embodiment of the present invention includes a buffer management section 10, a transmission packet registering section 11, a same-time schedule searching section 12, a search-data clearing section 13, a current-time schedule searching section 14, a same-time packet group sending request section 15, a scheduling request section 16, a timer section 17, a CAM (content-addressable memory) interface section 18, a packet buffer section 20, a traffic parameter section 21, a same-time transmission packet management table 22, and a content-addressable memory (CAM) 23.

The buffer management section 10 performs the input/output processing of packets and the recording of packets in the packet buffer section 20 for each flow of packets. The packet buffer section 20 records packet data.

The scheduling request section 16 calculates an ideal transmission time for a packet based on its traffic parameter, and issues a scheduling request to the same-time schedule searching section 12. The traffic parameter section 21 holds traffic parameters.

The same-time schedule searching section 12 searches the content-addressable memory 23 to determine whether there is a packet that has already been set to be transmitted at the same time. The transmission packet registering section 11 registers a transmission time onto the content-addressable memory 23, and further sets first and second tables for managing packets that are to be output at the same time in the same-time transmission packet management table 22. The same-time transmission packet management table 22 manages packets that have been set to be transmitted at the same time.

The timer section 17 counts time, and outputs a value of the current time to the current-time schedule searching section 14 and the scheduling request section 16. The current-time schedule searching section 14 searches the content-addressable memory 23 for transmission packets to be transmitted at the current time. The search-data clearing section 13 clears the searched data (set time data) from the content-addressable memory 23.

The same-time packet group sending request section 15 designates an address searched for by the current-time schedule searching section 14 to make a request for packet transmission from the buffer management section 10. The CAM interface section 18 is an interface for data searching and data writing to the content-addressable memory 23.

The content-addressable memory 23 is a kind of a memory device having a function of retrieving a table that matches search-data. When the content-addressable memory 23 has detected a table that matches the search-data, the content-addressable memory 23 outputs a registered address of the retrieved table.

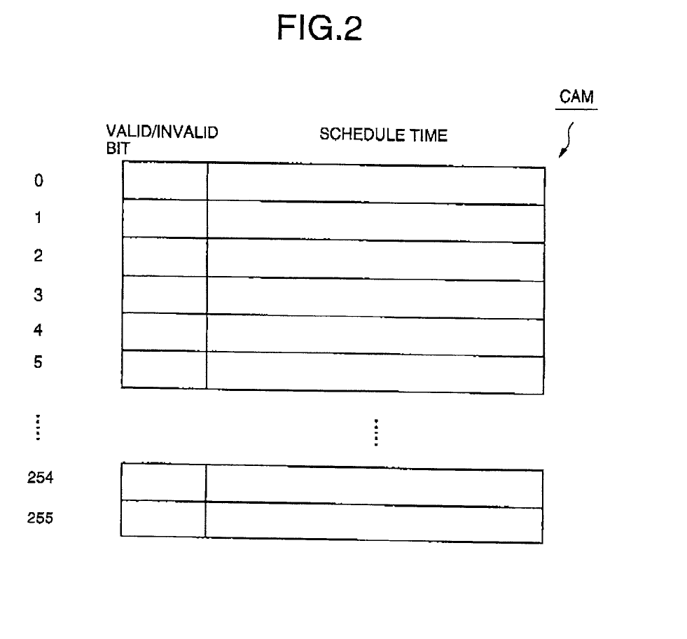

Referring to FIG. 2, the content-addressable memory 23 has a valid/invalid bit field and a schedule time field. The searching of the content-addressable memory 23 is performed among tables registered in the content-addressable memory 23.

The valid/invalid bit field is an area that stores a bit indicating whether the matching of a table registered at a corresponding address is activated. When a table is not to match the search-data, “0” is registered in this table. Contrarily, when a table is to match the search-data, “1” is always registered in this table. The schedule time field is an area in which a transmission schedule time is registered.

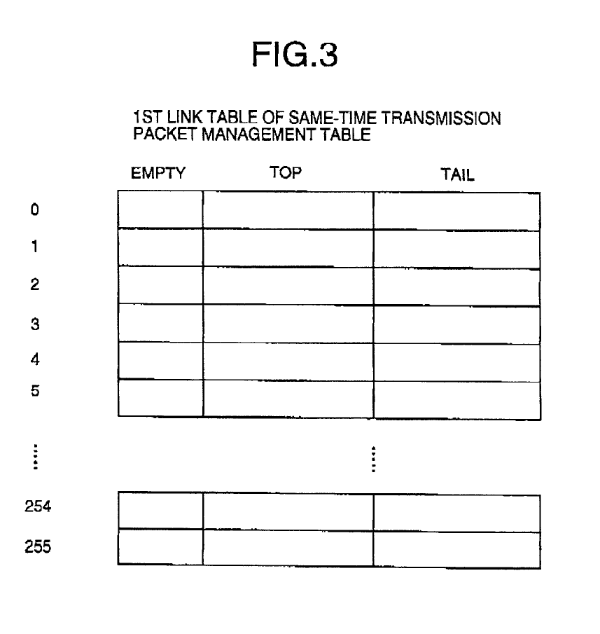

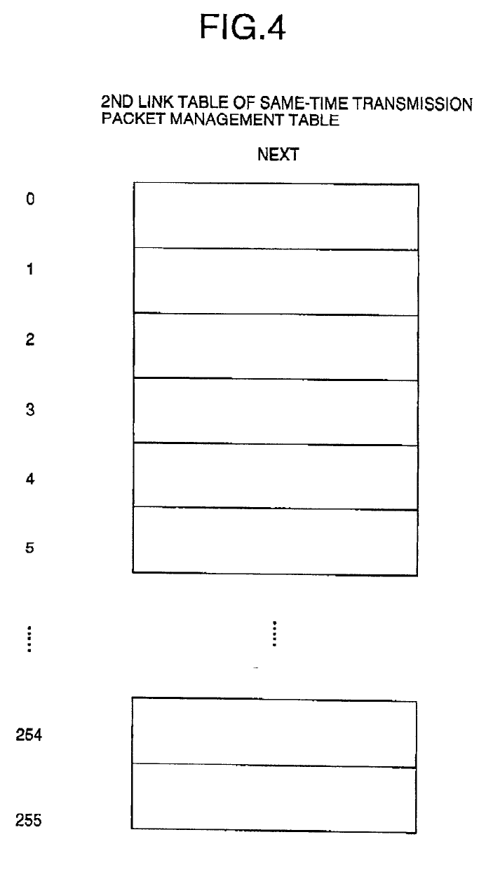

As shown in FIG. 3 and FIG. 4, the same-time transmission packet management table 22 stores a first table and a second table which are used to manage packets that are to be transmitted at the same time. Among packets that belong to the same flow, a packet that has been input first is output first. Therefore, a packet that is positioned at the top of each flow in the packet buffer section 20 is transmitted first. Accordingly, flow numbers can be used to manage packets that are to be transmitted at the same time. The same-time transmission packet management table 22 utilizes a linkage structure indicated by the first table (FIG. 3) that holds TOP and TAIL pointers and the second table (FIG. 4) that shows next locations (NEXT) of each flow number. Examples will be described later.

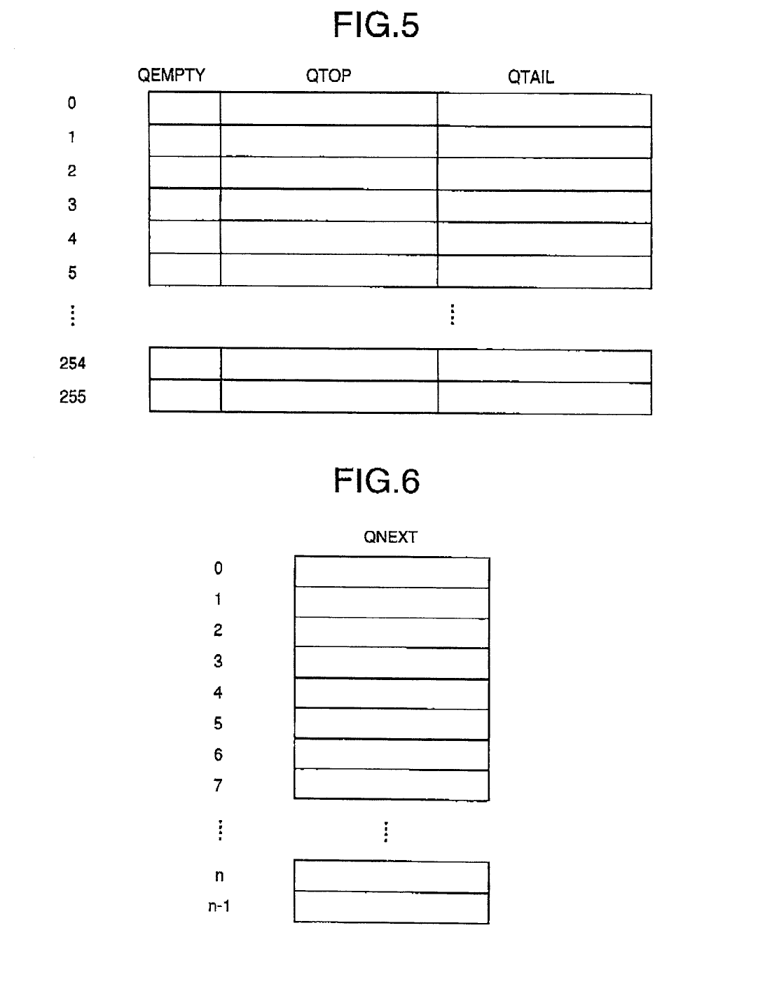

As shown in FIG. 5 and FIG. 6, the packet buffer section 20 holds the first and second tables for managing packets that belong to the same flow. The packet buffer section 20 also utilizes a linkage structure of the first and second tables to manage packets that belong to the same flow, similar to the case of the same-time transmission packet management table 22.

### OPERATIONS

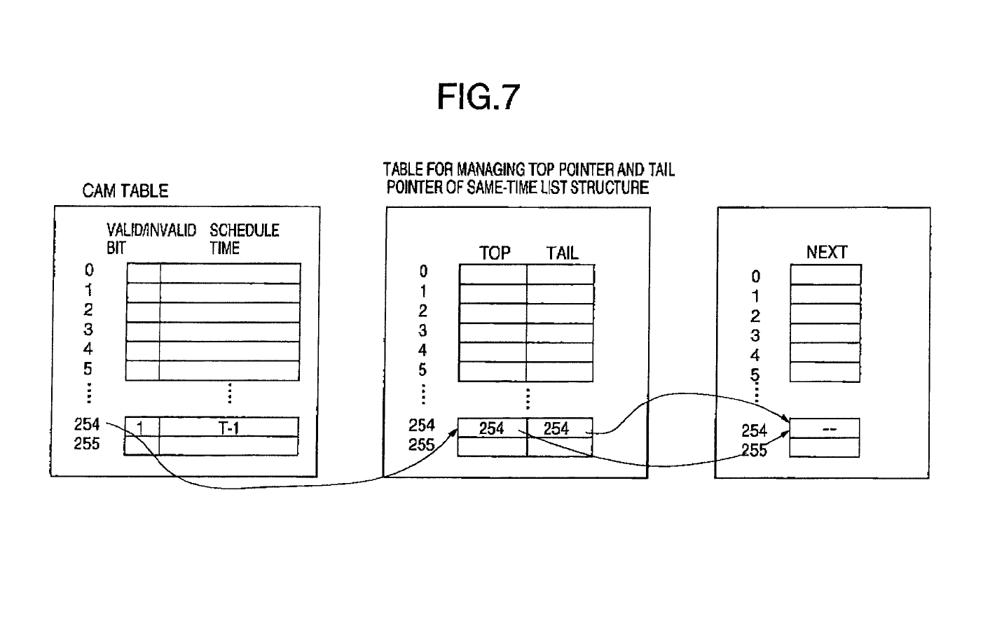

As shown in FIG. 7, in the case where only one packet is to be transmitted at a certain time instant (T-1), a corresponding flow number “254” of the CAM 23 is registered in both the TOP and TAIL pointers at the flow number “254” of the first table and no data is registered in the NEXT field at the flow number “254” of the second table.

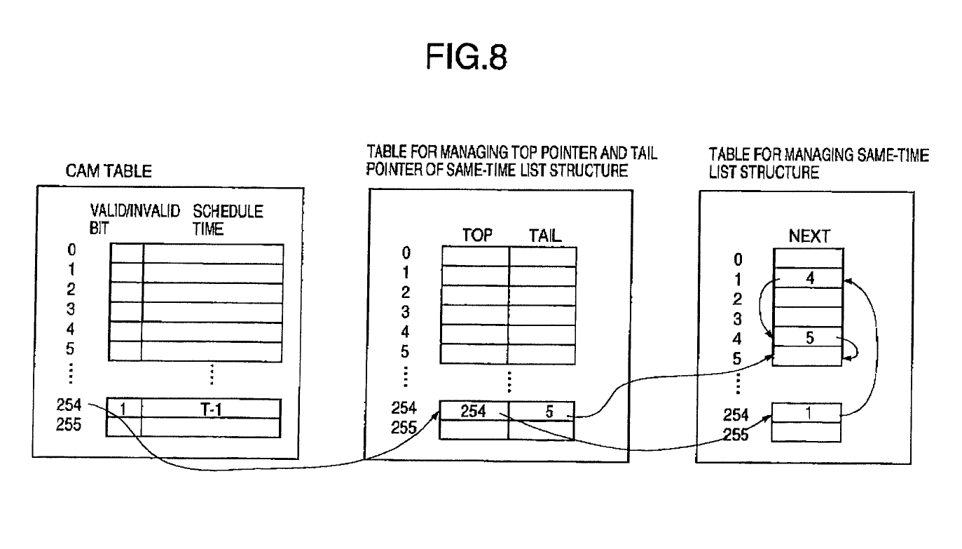

As shown in FIG. 8, in the case where a plurality of (three) packets are to be transmitted at a certain time instant (T1), a flow number “254” corresponding to the top packet is registered in the TOP pointer and a flow number “5” corresponding to the tail packet is registered in the TAIL pointer at the flow number “254” of the first table. Further, the linkage structure from the top packet to the tail packet is registered in the second table as shown in FIG. 8. The details will be described hereafter.

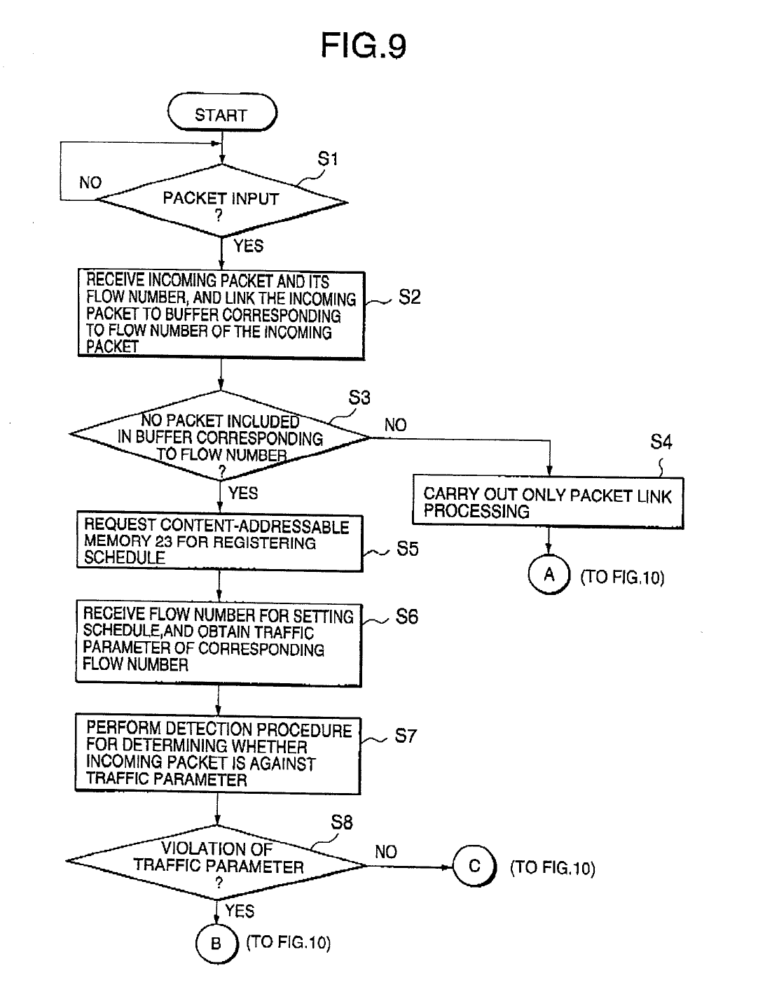

Referring to FIG. 9 through FIG. 12, an operation of the shaper according to the embodiment of the present invention will be described. The processing operation may be performed by running control programs on a program-controlled processor. The programs are previously stored in a control memory such as a ROM (read-only memory), an IC (integrated circuit) memory, or the like.

### PACKET INPUT PROCESSING

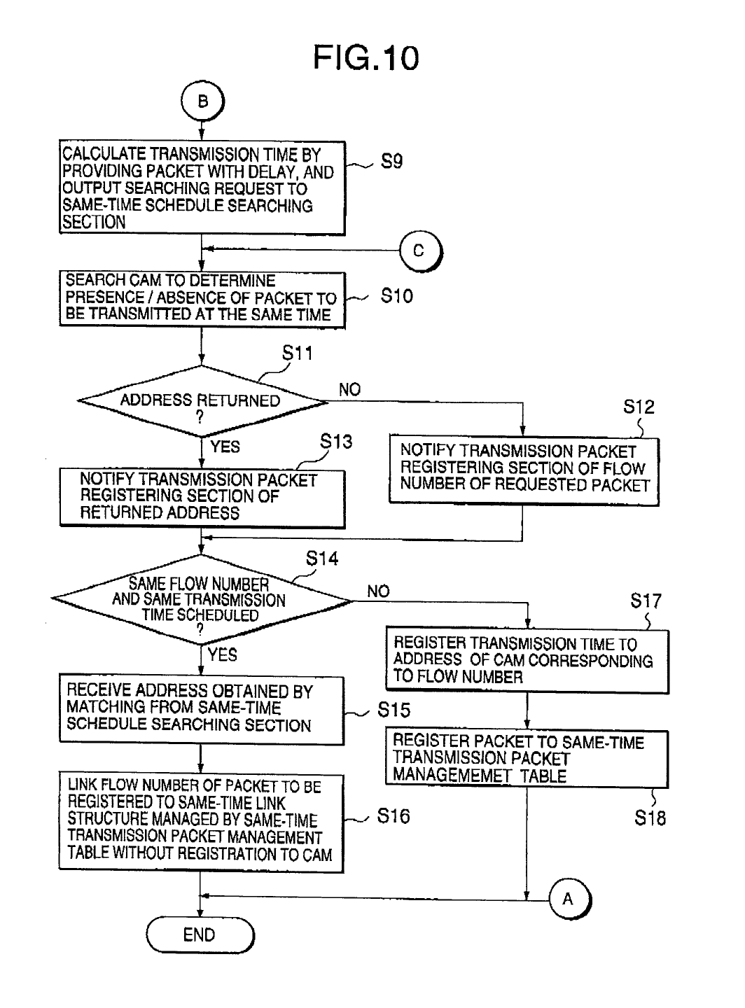

Referring to FIG. 9 and FIG. 10, when a packet has been input (YES at step S1 in FIG. 9), the buffer management section 10 receives the input packet and the flow number of the input packet, and links the input packet to a buffer corresponding to the flow number (step S2). Then, it is determined whether no packet is included in the buffer corresponding to the flow number (step S3).

When at least one packet has been already included in the corresponding buffer, which means that the packet is not the top packet of the flow number (NO at step S3), the buffer management section 10 carries out only the processing of linking the packet to the corresponding buffer for the flow number (step S4). Then, the packet input processing is finished.

When no packet is included in the corresponding buffer (YES at step S3), the input packet is the top packet for the flow number. In this case, it is necessary to register the transmission schedule for the packet in the content-addressable memory 23. Therefore, the buffer management section 10 requests the scheduling request section 16 for registering the schedule (step S5).

The scheduling request section 16 receives the flow number to be scheduled from the buffer management section 10, and obtains a traffic parameter of the corresponding flow number from the traffic parameter table 21 (step S6). Then, the scheduling request section 16 determines whether the input packet is against the traffic parameter (step S7).

When it has been found that the input packet is against the traffic parameter (YES at step S8), the scheduling request section 16 gives a delay to the packet, calculates a transmission time for transmitting the packet according to the current time output by the timer section 17, and issues a request for searching to the same-time schedule searching section 12 (step S9 in FIG. 10).

Traffic parameters are different depending on traffic models. In the ATM network, the Leaky Bucket model is used to express the traffic parameters, and in the IP network, the Token Bucket model is used to express the traffic parameters.

Upon receiving the searching request from the scheduling request section 16, the same-time schedule searching section 12 searches the content-addressable memory 23 to determine whether there is a packet that has already been set to be transmitted at the same time (step S10). The method of searching the content-addressable memory 23 and the search-data are similar to those of the same-time schedule searching section 14. However, the time used for the search-data is not the current time but the packet transmission time received from the scheduling request section 16.

When there is no packet to be transmitted at the same time and no address has been returned, which means that no packet to be transmitted at the same time has been registered in the content-addressable memory 23 (NO at step S11), the same-time schedule searching section 12 transfers the flow number of the packet requested from the scheduling request section 16 to the transmission packet registering section 11 (step S12).

When there is at least one packet to be transmitted at the same time and its address has been returned, which means that the packet to be transmitted at the same time has already been registered in the content-addressable memory 23 (YES at step S11), the same-time schedule searching section 12 transfers the returned address to the transmission packet registering section 11 (step S13).

As shown in FIG. 8, for example, a time instant T-1 has been registered to a flow number 254, and a packet transmission time has been set to the time T-1. In this case, the TOP is “254”, and the TAIL is “5”. When the first table for managing the same-time list structure is looked at, a flow number “1” comes next to the flow number “254”. A flow number “4” then comes next to the flow number “1” and the last is the flow number “5”.

When the same-time schedule searching section 12 has notified the transmission packet registering section 11 that the flow number and the scheduled transmission time of the packet to be registered are overlapped with those of another packet (YES at step S14), the transmission packet registering section 11 receives an address obtained as a result of the matching performed by the same-time schedule searching section 12 (step S15). The transmission packet registering section 11 does not carry out a registration to the content-addressable memory 23, and links the packet flow number to be registered to the linkage structure showing the sane transmission time managed by the same-time transmission packet management table 22 (step 516). The transmission packet registering section 11 uses the addresses received from the same-time schedule searching section 12 as the top and tail locations of the first table.

When the same-time schedule searching section 12 notifies the transmission packet registering section 11 that the flow number and the scheduled transmission time of the packet to be registered are not overlapped with those of another packet (NO at step S14), the transmission packet registering section 11 registers the transmission time to the address of the content-addressable memory 23 corresponding to the flow number (step S17). Then, the same-time schedule searching section 12 registers the packet to the same-time transmission packet management table 22 (step 518). In this case, there is only this packet to be set in the linkage structure. In other words, the top and the tail are the same.

### PACKET OUTPUT PROCESSING

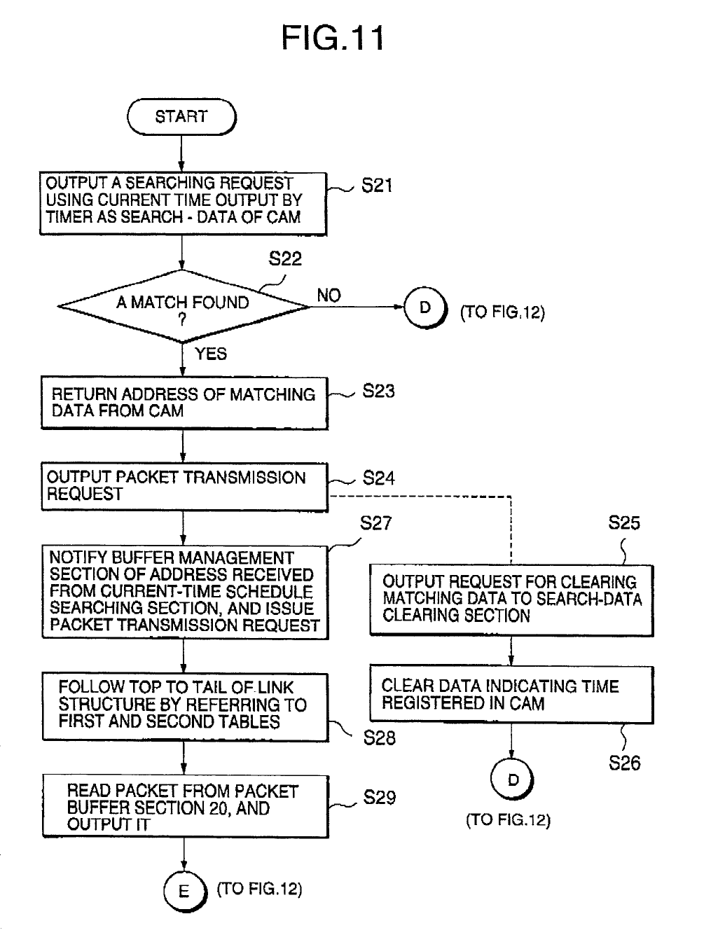

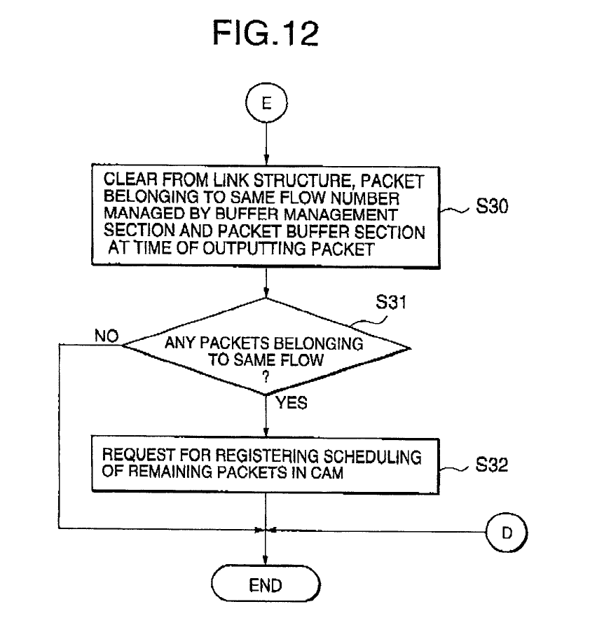

Referring to FIG. 11 and FIG. 12, the current-time schedule searching section 14 uses the current time data output by the timer section 17 as search-data of the content-addressable memory 23, and requests the CAM interface section 18 for carrying out the searching (step S21 in FIG. 11). The search-data is formed by adding a bit of “1” to the current time data, the bit corresponding to the valid/invalid bit field (see FIG. 2).

When data matching the search-data has been registered in the content-addressable memory 23 (YES at step S22), the content-addressable memory 23 returns the address of the matching data to the current-time schedule searching section 14 as a result (step S23).

When the address has been returned, the current-time schedule searching section 14 issues a packet transmission request to the same-time packet group sending request section 15 (stop S24). At the same time, the current-time schedule searching section 14 issues a matching-data clearing request to the search-data clearing section 13 (step S25).

When receiving the matching-data clearing request, the search-data clearing section 13 eliminates the matching data from the retrievable entries in the content-addressable memory 23 (step S26). More specifically, the search-data clearing section 13 sets the valid/invalid bit of the matching data to “0” in the content-addressable memory 23 (see FIG. 2). In the case where the valid/invalid bit of an entry in the content-addressable memory 23 is set to “0”, the entry cannot match the search-data in the current-time schedule searching section 14 because the currant-time schedule searching section 14 performs the searching by setting the-bit of the search-data corresponding to the valid/invalid bit to “1”.

When data matching the search-data has not been registered in the content-addressable memory 23 (NO at step S22) the processing is finished. Then, the data searching is awaited until when the timer section 17 reaches the next time to output next-time data. The data searching is carried out when the timer section 17 has output the next time.

The same-time packet group sending request section 15 carries out the interface processing such that the address received from the current-time schedule searching section 14 is transferred to the buffer management section 10, and issues a packet transmission request to the buffer management section 10 (step S27).

When receiving the packet transmission request from the same-time packet group sending request section 15, the buffer management section 10 receives the address of the matching data as a result of the searching in the content-addressable memory 23, from the same-time packet group sending request section 15. The received address shows a location of the table that holds the TOP and TAIL pointers in the same-time transmission packet management table 22 (see FIG. 3).

The buffer management section 10 reads the TOP pointer and the TAIL pointer indicated by the received address, and sequentially accesses the locations of the linkage structure from the top location indicated by the TOP pointer to the tail location indicated by the TAIL pointer in the second table. The respective locations represent the flow numbers that are to be transmitted at the same time. In other words, these show the head packets of buffers corresponding to the flow numbers, respectively.

In this manner, the buffer management section 10 follows the top to the tail (step S28 in FIG. 11), reads a series of packets from the top to the tail from the packet buffer section 20, and outputs these packets (step S29). At the time of outputting the packets, the buffer management section 10 clears the packets that belong to the same flow number managed by the buffer management section 10 and the packet buffer section 20, from the linkage structure (step S30 in FIG. 12).

If there are still any packets that belong to the same flow (YES at step S31), the buffer management section 10 requests the scheduling request section 16 for registering the scheduling of these remaining packets in the content-addressable memory 23 (step S32).

As explained above, the schedule time is registered as to-be-retrieved data in the content-addressable memory 23, and the current-time schedule searching section 14 searches the content-addressable memory 23 using the current time as a search key. With this arrangement, it is possible to obtain the address registered at the schedule time. Therefore, the buffer management section 10 can obtain a flow number or a series of flow numbers based on this address as shown in FIG. 8. Therefore, it is possible to restrict an increase in the amount of hardware, and a large-capacity memory is not necessary.

Further, in the same-time transmission packet management table 22, a plurality of packets to be transmitted at the same time are managed in form of a linkage structure. The same-time schedule searching section 12 previously retrieves a schedule time at the time of searching the content-addressable memory 23 based on the transmission time. Therefore, even if a plurality of packets to be transmitted at the same time exists, it is possible to easily search for them and transmit them at the same time.

Further, when a packet has arrived at the buffer management section 10, the buffer management section 10 issues a scheduling request to the scheduling request section 16. The scheduling request section 16 then calculates the packet transmission time based on its traffic parameter. Therefore, it is possible to determine its transmission time other than the predetermined time intervals.

Further, when the buffer management section 10 has output a packet, the buffer management section 10 determines whether any packets of the flow number belonging to the output packet are held in the buffer. When packets belonging to the same flow number exist in the buffer, the buffer management section 10 issues a request for scheduling to the scheduling request section 16. Therefore, it is possible to not only transmit packets at regular intervals but also set a transmission time to an arbitrary time (scheduling) by calculation from the traffic parameter.

In the above-described embodiment, a data format that has a linkage structure is used for the same-time transmission packet management table 22 and the packet buffer section 20. However, in the same-time transmission packet management table 22, FIFO (first-in and first-out) queue data structures each capable of storing date of a maximum number of flows may be prepared as many as the flows.

Further, in the packet buffer section 20, it is also possible to manage buffers for each of flow numbers. It is possible to use any algorithm that has a data structure having a mechanism of extracting a top packet of each flow and a mechanism of adding a packet to the tail of each flow.

As described above, according to the present invention, even when a plurality of packets have been set to the same transmission time in the content-addressable memory, it is possible to transmit them at the same timing.

Further, there is provided means for calculating a transmission time of a packet using the traffic parameter of a predetermined transmission path. Based on the registration of the calculated transmission time to the content-addressable memory as a schedule time, there is an effect that it is possible to determine a transmission time based on a packet arrival time and the traffic parameter.

1. A shaper for controlling a plurality of flows of packets, comprising:
a packet buffer for storing packets for each of the flows of packets;
a content-addressable memory for storing a plurality of scheduled transmission times at different addresses each corresponding to the flows of packets;
a timer counting a current time; and
a current-time searcher for searching the content-addressable memory for a scheduled transmission time matching the current time to determine whether a packet to be transmitted at the current time exists.

2. A shaper for controlling a plurality of flows of packets, comprising:
a packet buffer for storing packets for each of the flows of packets;
a content-addressable memory for storing a plurality of scheduled transmission times, at each of which at least one packet is to be transmitted;
a packet management table for storing linkage information indicating a linkage of a plurality of packets that are to be transmitted at a same scheduled transmission time;
a timer counting a current time;
a current-time searcher for searching the content-addressable memory for a scheduled transmission time matching the current time; and
a packet transmission controller for transmitting at least one packet at the scheduled transmission time matching the current time by ref erring to the packet management table.

3. A shaper according to claim 2, further comprising:
a scheduler for calculating a transmission time of an input packet based on its predetermined traffic;
a same-time searcher for searching the content-addressable memory to determine whether the calculated transmission time matches a scheduled transmission time that has been already registered in the content-addressable memory; and
a transmission registration controller for adding the input packet to the linkage for the calculated scheduled transmission time in the packet management table, when the calculated transmission time matches a scheduled transmission time that has been already registered in the content-addressable memory.

4. A shaper according to claim 3, further comprising:
a data update controller for eliminating the scheduled transmission time matching the calculated transmission time from entries to be searched for in the content-addressable memory.

5. A shaper according to claim 4, wherein the data update controller removes a packet that has been transmitted from a corresponding linkage stored in the packet management table.

6. A shaper according to claim 4, wherein the data update controller uses a valid/invalid flag to determine whether a scheduled transmission time is eliminated from entries to be searched for in the content-addressable memory.

7. A shaper according to claim 3, wherein the transmission registration controller registers a flow number of the input packet into the content-addressable memory as an address of the content-addressable memory, when the calculated transmission time does not match any scheduled transmission time of the content-addressable memory.

8. A shaper according to claim 3, wherein the scheduler calculates a transmission time of an input packet so as to meet its predetermined traffic parameter.

9. A scheduling method for use in a shaper controlling a plurality of flows of packets, comprising the steps of:
a) calculating a transmission time of an input packet based on its predetermined traffic;
b) searching a content-addressable memory to determine whether the calculated transmission time matches a scheduled transmission time that has been already registered in the content-addressable memory;
c) when the calculated transmission time matches a scheduled transmission time that has been already registered in the content-addressable memory, adding the input packet to a linkage for the calculated scheduled transmission time in a packet management table;
d) when the calculated transmission time does not match any scheduled transmission time of the content-addressable memory, registering a flow number of the input packet into the content-addressable memory as an address of the content-addressable memory;
e) searching the content-addressable memory for a scheduled transmission time matching a current time at predetermined intervals; and
f) transmitting at least one packet at the scheduled transmission time matching the current time by referring to the packet management table.

10. A scheduling method according to claim 9, further comprising the step of:
eliminating the scheduled transmission time matching the calculated transmission time from entries to be searched for in the content-addressable memory.

11. A scheduling method according to claim 10, further comprising the step of:
removing a packet that has been transmitted from a corresponding linkage stored in the packet management table.

12. A scheduling method according to claim 9, wherein a transmission time of an input packet is calculated so as to meet its predetermined traffic parameter.
